(19) United States
(12) Patent Application Publication
(10) Pub. No.: US 2016/0096780 A1
(43) Pub. Date: Apr. 7, 2016

(54) SOLID COMBUSTIBLE PROPELLANT COMPOSITION

(71) Applicant: Goodrich Corporation, Charlotte, NC (US)

(72) Inventor: Michael George Mangum, Fairfield, CA (US)

(21) Appl. No.: 14/508,746

(22) Filed: Oct. 7, 2014

(51) Int. Cl. C06B 31/30; F02K 9/08; C06B 31/32

(52) U.S. Cl. CPC C06B 31/30; C06B 31/32; F02K 9/08

(57) ABSTRACT

A solid combustible propellant composition is disclosed comprising a solid oxidizer composition comprising ammonium nitrate and at least one other solid oxidizer having a decomposition or melting temperature of at least 500° C., a fuel, and a polymer binder that decomposes by chain scission to undergo liquefaction during combustion of the propellant composition.

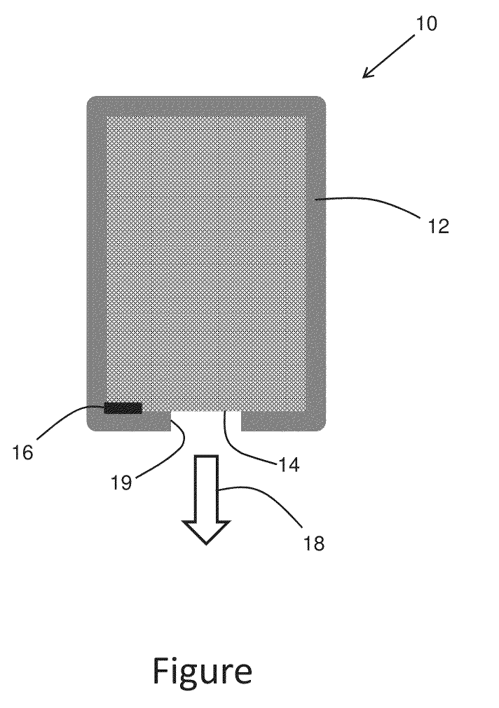

### BACKGROUND OF THE INVENTION

This invention relates to environmental air conditioning systems (ECS), and more specifically to air cycle environmental air conditioning systems such as used on aircraft

This invention relates to solid combustible propellant compositions for a variety of propellant applications.

Combustible solid propellants are well-known for a variety of applications, including but not limited to air bag inflators, inflator cartridges for portable pneumatic tools, rocket propulsion systems, as well as propellants for a variety of ballistic launch systems. Ammonium perchlorate has been widely used as an oxidizer in composite compositions that also include a high-energy fuel and a polymer binder. Ammonium perchlorate offers a number of desired performance features such as performance, processability, and burning rate. However, ammonium perchlorate causes environmental and health problems through the release of hydrogen chloride into the environment. The chronic exposure to perchlorates, even in low concentrations, has been shown to cause various thyroid problems. The problems from ammonium perchlorate in propellants can become acute in areas with localized persistent use of propellant compositions such as at rocket launch sites or munitions test ranges. Development of drinking water standards for perchlorate in the United States is discussed in Journal of Environmental Management, Volume 91, Issue 2, Pages 303-310 Katarzyna H. Kucharzyk, Ronald L. Crawford, Barbara Cosens, Thomas F. Hess.

Additionally, ammonium perchlorate propellant compositions often fail to meet at least one of the requirements for Insensitive Munitions, such as smoke production levels (minimum signature, reduced smoke, or high performance), slow cook-off (SCO), fast cook-off (FCO), bullet impact (BI), fragment impact (FI), sympathetic detonation (SD), or shape charge jet (SCJ). For example, ammonium perchlorate can be subject to a rapid decomposition upon heating, leading to a catastrophic detonation of the propellant composition. The above requirements are further are further described at USC, title 10, Chapter 141, Section 2389 December 2001 “§2389, Ensuring safety regarding insensitive munitions. The Secretary of Defense shall ensure, to the extent practical, that insensitive munitions under development or procurement are safe throughout development and fielding when subject to unplanned stimuli.”; NAVSEAINST 8010.5, TB 700-2 (8020.8C); HAZARD ASSESSMENT TESTS FOR NON-NUCLEAR MUNITIONS, Department of Defense Ammunition and Explosive Hazard Classification Procedure, MIL-STD-2105D; STANAG 4439—Policy for Introduction and Assessment of Insensitive Munitions (IM); STANAG 4382—Slow Heating, Munitions Test Procedure; STANAG 4240—Liquid Fuel/External Fire, Munitions Test Procedure; STANAG 4241—Bullet Impact, Munitions Test Procedure; STANAG 4396—Sympathetic Reaction, Munitions Test Procedure; STANAG 4496—Fragment Impact, Munitions Test Procedure; STANAG 4526—Shape Charge Jet, Munitions Test Procedure.

### BRIEF DESCRIPTION OF THE INVENTION

According to an aspect of the invention, a propellant composition comprises:

a solid oxidizer composition comprising ammonium nitrate and at least one other solid oxidizer having a decomposition or melting temperature of at least 500° C.;

a fuel; and

a polymer binder that decomposes by chain scission to undergo liquefaction during combustion of the propellant composition.

According to another aspect of the invention, a method of discharging a propellant comprises:

combusting, in an enclosed vessel comprising at least one discharge opening, a composition comprising a solid oxidizer composition comprising ammonium nitrate and at least one other solid oxidizer having a decomposition or melting temperature of at least 500° C., a fuel, and a polymer binder that decomposes by chain scission to undergo liquefaction during combustion of the propellant composition; and

discharging combustion gases produced by combustion of the composition as a propellant through the discharge opening.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying figures, in which:

The FIGURE is a schematic depiction of a propellant discharge device.

### DETAILED DESCRIPTION OF THE INVENTION

As mentioned above, the propellant composition comprises a solid oxidizer composition comprising ammonium nitrate. In some embodiments, the ammonium nitrate is a (PSAN). Ammonium nitrate that has not been phase stabilized can be subject to phase or other changes in crystalline structure such as may be associated with volumetric expansion such as may occur during temperature cycling over the normally expected or anticipated range of storage conditions. For example, storage conditions for warehoused components or munitions can vary widely in a range from −40° C. to about 110° C. Changes of form or structure of the ammonium nitrate crystalline structure may result in physical degradation of the solid composite of the propellant composition. In particular, ammonium nitrate is known to undergo temperature-dependent changes through five phase changes, i.e., from Phase I through Phase V, with an especially significant volume change of ammonium nitrate associated with the reversible Phase IV to Phase III transition. Furthermore, such changes, even when relatively minute, can strongly influence the physical properties of a corresponding combustible solid propellant and, in turn, adversely affect the burn rate of the combustible solid propellant.

It has been found that the phase change-induced degradation of pelletized ammonium nitrate-containing compositions can be mitigated if the humidity is kept extremely low. However, maintaining such low humidity level is often impractical for most manufacturing situations, so various forms of phase-stabilized ammonium nitrate compositions have been developed. In particular, ammonium nitrate has typically been phase-stabilized by admixture and/or reaction with minor amounts of additional chemical species. For example, U.S. Pat, No. 5,071,630 teaches stabilization with zinc oxide (ZnO), U.S. Pat. No. 5,641,938 teaches stabilization with potassium nitrate (KNO₃), and U.S. Pat. No. 5,063,036 teaches stabilization with cupric oxide (CuO). U.S. Pat. No. 6,059,906 teaches stabilization with a molecular sieve age stabilizing agent and a strengthening agent. However, many prior art compositions utilizing alternative oxidizers to ammonium perchlorate suffer from poor burn rate or from a less than optimal combination of various factors such as density, caloric output, specific impulse, and volumetric impulse.

As mentioned above, ammonium nitrate can be phase stabilized such as in a co-crystal form with potassium nitrate or other salts, as disclosed by U.S. Pat. Nos. 5,071,630; 5,641,938; 5,063,036; and 6,059,906, the disclosures of each of which are incorporated herein by reference. During combustion of the propellant composition, PSAN undergoes a decomposition phase change to a liquid state, removing energy from the system, which can help the composition attain one or more of the insensitive munitions benchmarks. This differs from ammonium perchlorate, which also decomposes but produces decomposition products that can detonate catastrophically. Additionally, higher levels of PSAN can help reduce smoke emissions from combustion of the propellant while providing a low environmental impact. In some exemplary embodiments, the propellant composition comprises at least 20 wt. % PSAN. In some exemplary embodiments, the propellant composition comprises at least 25 wt. % PSAN, more specifically at least 28 wt. %. Unless otherwise stated, all weight percentages disclosed herein are based on the total weight of the propellant composition). Upper limits on the amount of PSAN will be dictated by performance specifications such as burn rate, impulse, and thrust. In some embodiments, the propellant composition comprises less than or equal to 15 wt. % PSAN. In some embodiments, the propellant composition comprises less than or equal to 5% PSAN. The disclosed upper and lower PSAN content limits serve also to disclose a number of ranges of values for PSAN content in the propellant composition.

Various other chlorine-free oxidizers can be used in the invention, alone or in combination. As mentioned above, at least one oxidizer has a melting point above 500° C. This helps to provide the propellant composition with thermal stability that complements the energy absorbing decomposition of ammonium nitrate at lower temperatures. Exemplary oxidizers include but are not limited to other nitrates, periodates, metal oxides or iodates. Nitrate, periodate, and iodate salts typically utilize ammonium, alkylammonium or a metal cation. Metal cations can include an alkali metal (e.g., potassium), an alkaline earth metal (e.g., strontium), or a transition or post-transition metal (e.g., copper or bismuth). Tungsten, zinc, silver, and other non-toxic and environmentally friendly cations that can be used. Exemplary useful are cations, salts, and oxidizers that provide densities greater than ammonium perchlorate density of 1.95 grams/cm³. Exemplary useful oxidizers are those with a positive oxygen balance (O.B.) (e.g., potassium periodate with an O.B.=27.8). Exemplary pairings of cations and anions include potassium —periodate, bismuth—oxide, cupric—oxide, cupric—nitrate, bismuth-nitrate, lithium—periodate, and ammonium-periodate. Metal oxide oxidizers include oxides of bismuth copper, tungsten, zinc, molybdenum, and various high density metals. In some embodiments, the metal oxide is capable of being reduced by a metal fuel in the propellant composition. The metal oxides decompose at combustion temperatures to produce oxygen that oxidizes the fuels present in the composition. Specific examples of other oxidizers include potassium periodate, potassium nitrate, strontium nitrate, cupric nitrate, bismuth nitrate, bismuth oxide, cupric oxide, tungsten oxide. Oxidizers can be present in the propellant composition at levels of about 30 wt. % to about 70 wt. %, more specifically from about 55 wt. % to about 65 wt. %, and even more specifically from about 58 wt. % to about 62% wt. %.

The fuel in the propellant composition can be provided by a variety of components. The polymer binder is of course a fuel source, and is discussed in further detail below. Additional fuel components can be included in the form of nitroplasticizers, nitramines, or energetic additives. Typical nitroplasticizers include, but are not limited to nitrate esters, many liquid phase, such as trimethylol ethane trinitrate (TMETN), triethylene glycol dinitrate (TEGDN), triethylene glycol trinitrate (TEGTN), butanetriol trinitrate (BTTN), diethyleneglycol dinitrate (DEGDN), ethyleneglycol dinitrate (EGDN), nitroglycerine (NG), diethylene glycerin trinitrate (DEGTN), dinitroglycerine (DNG), nitrobenzene (NB), N-butyl-2-nitratoethylnitramine (BNEN), methyl-2-nitratoethylnitramine (MNEN), ethyl-2-nitratoethylnitramine (ENEN) or mixtures thereof. In an embodiment, the nitroplasticizer can be a 50-50 by weight mixture of TMETN and TEGDN. The nitroplasticizer can be present in the composition at levels up to about 40 wt. %, more specifically from 4-22 wt. %. Energetic additives are solid phase nitrogen-rich auxiliary fuel components. Examples of energetic additives include, but are not limited to, azodicarbamide (AZT), dinitroxydiethylnitramine (DNDEN), cyclotrimethylene trinitramine (RDX), cyclotetramethylene tetranitramine (HMX), 3-nitro-1,2,4-triazol-5-one (NTO), 1,1-diamino-2,2-dinitroethylene (FOX-7), or mixtures thereof. Energetic additives can be present in the propellant composition amounts up to about 40%. In some embodiments, nitroplasticizers or energetic additives are used that provide relatively low temperature, non-catastrophic burning, or a non-detonating decomposition reaction. Such fuels include, but are not limited to 3-nitro-1,2,4-triazol-t-one (NTO), 1,1-diamino-2,2-dinitroethylene (FOX-7), TEGDN, TMETN, BNEN, or BTTN. In some embodiments, the nitroplasticizer or energetic additive is NTO or FOX-7, or a mixture thereof.

In some embodiments, the fuel includes one or metal powders. As used herein, the term “metal powder” includes powders of metals and of metal hydrides. Examples of metal powders include but are not limited to aluminum, magnesium, zirconium, zirconium hydride, titanium, titanium hydride, aluminum-silicon powder, magnesium-aluminum powder, and boron. Particle sizes of the metal powders can range from about 10 nm to about 20 μm to, and more specifically from about 2 μm to about 10 μm. The amounts and particle sizes of metal fuel can vary depending on system design parameters. Generally, larger amounts of metal fuel increase combustion temperature and volumetric impulse, but in too large of an amount they can cause metal oxide precipitate in the propellant exhaust, which can reduce velocity and lead to equipment fouling and breakdown. In some embodiments, the propellant composition comprises from about 1 to about 25 wt. % of metal powder, more specifically from about 16 wt. % to about 22 wt. %. In embodiments where a reduced smoke propellant is needed, the propellant composition can comprise from about 1 wt. % to about 5 wt. % metal powder.

In some embodiments, the propellant composition can include a dodecaborate salt, which is a salt of dodecahydrodecaboric acid such as cesium dodecaborate, potassium dodecaborate, lithium dodecaborate, ammonium dodecaborate, or tetralkylammonium dodecaborate. The salts can be characterized by the formula M⁺²[B₁₂H₁₂]⁻² where M is a metal or ammonium in a stoichiometric amount to balance the −2 charge of the dodecaborate anion. Dodecaborate salts are available from commercial chemical suppliers, and can be included in the propellant composition in amounts from about 0.5 wt. % to about 10.0 wt. %, more specifically from about 1.0 wt. % to about 5.0 wt. %, and even more specifically from about 2.0 wt. % to about 4.0 wt. %.

Other additives can be included as well, as known in the art, including but not limited to cure catalysts (e.g., triphenyl bismuth or butyl tin dilaurate, a metal acetylacetonate), nitrate ester stabilizers (e.g., N-methyl-4-nitroaniline (MNA), 2-nitrodiphenylamine, (NDA), ethyl centralite (EC), antioxidants (e.g., 2,2′-bis(4-methyl-6-t-butylphenol), and amorphous carbon powder

The polymer binder of the propellant composition can be a thermoplastic or it can be a thermoset composition that relies on a chemical curing mechanism. The polymer binder can be present in the propellant composition in an amount ranging from about 5 wt. % to about 18 wt. %, and even more specifically from about 8 wt. % to about 12 wt. %. Thermoset polymer binder compositions can contain one or more resins having polyfunctional groups that react with other resin functional groups or with a polyfunctional curing agent having groups reactive with the resin functional groups. As mentioned above, the polymer binder should decompose by chain scission to undergo liquefaction during combustion of the propellant composition. Such a decomposition of the polymer binder absorbs energy from the system, which can help the composition attain one or more of the insensitive munitions benchmark responses. Hydroxy-terminated polybutadiene (HTPB) is a commonly used binder resin for propellant composition; however, it does not undergo liquefaction during combustion. Polymers that do undergo chain scission to cause liquefaction during combustion include polyesters, polyethers, or polyester polyether copolymers. Examples of polyfunctional resins include hydroxy terminated polyether (HTPE), polyglycol adipate (PGA), glycidylazide polymer (GAP), poly bis-3,3′-azidomethyl oxetane (BAMO), poly-3-nitratomethyl-3-methyl oxetane (PNMMO), polyethylene glycol (PEG), polypropylene glycol (PPG), cellulose acetate (CA) or mixtures thereof. Curing agents include, but are not limited to, hexamethylene diisocyanate (HMDI), isophorone diisocyanate (IPDI), toluene diisocyanate (TDI), trimethylxylene diisocyanate (TMDI), dimeryl diisocyanate (DDI), diphenylmethane diisocyanate (MDI), naphthalene diisocyanate (NDI), dianisidine diisocyanate (DADI), phenylene diisocyanate (PDI), xylylene diisocyanate (MXDI), other diisocyanates, triisocyanates, higher isocyanates than the triisocyanates, polyfunctional isocyanates (e.g., Desmodur N 100), other polyfunctional isocyanates or mixtures thereof. In some embodiments, the curing agent has least two reactive isocyanate groups. If there are no binder ingredients with a functionality that is greater than 2, then the curative functionality (e.g., number of reactive isocyanate groups per molecule of isocyanate curing agent) must be greater than 2.0. If there are binder polymers with a functionality of two or less, then an isocyanate with functionality greater than two is used. The amount of the curing agent is determined by the desired stoichiometry (i.e., stoichiometry between curable binder and curing agent). In some embodiments, the curing agent is present in the propellant composition in an amount of about 0.5 wt. % to about 5%.

The combustible solid propellant composition can be prepared by blending the above-described components, i.e., oxidizer, fuel, polymer binder (or components thereof, e.g., polyfunctional resin and polyfunctional curing agent), dodecaborate salt, and any additional or optional components in a mixing vessel. During the working time of the uncured resin composition, the mixture can be molded or cast into a desired shape or extruded and pelletized. After cure of the polymer binder is complete, the solid propellant can be fitted into a propellant module for use in various applications such as an airbag inflator or a rocket motor. An exemplary propellant module is depicted in the FIGURE, where propellant module 10 has a housing or vessel 12 with a solid propellant composition 14 therein. Upon activation of combustion by ignition device 16 (e.g., an electronic ignition device), combustion of the solid propellant composition 14 produces combustion gases 18 that are exhausted as propellant through opening 19.

The invention is further described in the following Examples set forth below.

### Examples

Propellant compositions were prepared by blending the components specified in Table 1, molding the resulting mass into a shape for testing, and curing to form solid articles for testing. Heat of explosion (HOE), density, impulse, and volumetric impulse were measured, and the results are also set forth in Table 1. Several of the tests are conducted according to methods described in MIL-STD-286.

TABLE 1

| | Examples of Insensitive Munitions High Performance Propellant | | | | | | |
|---|---|---|---|---|---|---|---|
| | Example 1 | Example 2 | Example 3 | Example 4 | Example 5 | Example 6 | Comparison |
| Propellant Ingredients | | | | | | | |
| Binder (Polyester or Polyether | 9-10% | 9-10% | 9-10% | 9-10% | 9-10% | 9-10% | 9-11.5 |
| polyol + Isocyanate curative + | | | | | | | |
| Stabilizers + Additives) | | | | | | | |
| Nitrate Ester Plasticizers | 5-15% | 5-15% | 5-15% | 7-17% | 7-17% | 7-17% | 18-22% |
| Metal powder (example Aluminum) | 10-18% | 18-26% | 18-26% | 18-26% | 18-26% | 14-24% | 0% |
| NTO (3-nitro-1,2,4-triazol-5-one) | | | | 5-20% | | 5-20% | |
| FOX-7 (1,1-diamino-2,2- | | | | | 5-20% | | |
| dinitroethylene) | | | | | | | |
| Potassium Periodate | 10-25% | | 20-35% | 15-30% | 15-30% | 10-20% | — |
| Bismuth Trioxide | 17.0% | 30.0% | | | | 10-20% | — |
| Phase Stabilized Ammonium Nitrate | 20-35% | 20-35% | 20-35% | 20-30% | 20-30% | 20-30% | 48-55% |
| (PSAN) | | | | | | | |
| Azodicarbonamide (AZD) | | | | | | | 15-20% |
| Performance Properties | | | | | | | |
| HOE (cal/g) | 1150 ± 100 | 1100 ± 100 | 1450 ± 100 | 1400 ± 100 | 1400 ± 100 | 1200 ± 100 | 850 ± 100 |
| Density (g/cm³) | 1.9-2.4 | 2.0-2.4 | 1.9-2.4 | 1.9-2.4 | 1.9-2.4 | 1.9-2.4 | 1.5-1.6 |
| Theoretical Volumetric Impulse (lbf- | 17-18 | 17-18 | 17-18 | 17-18 | 17-18 | 17-18 | 11.0-11.8 |
| s/in³) | | | | | | | |

As shown in Table 1, the compositions of the Examples provided significantly greater stability as indicated by the higher HOE values versus the comparison. Additionally much higher performance (density, volumetric impulse) is obtained with the Example compositions versus the comparison.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A solid combustible propellant composition, comprising:
a solid oxidizer composition comprising ammonium nitrate and at least one other solid oxidizer having a decomposition or melting temperature of at least 500° C.;
a fuel; and
a polymer binder that decomposes by chain scission to undergo liquefaction during combustion of the propellant composition.

2. The composition of claim 1, comprising at least 20 wt. % of ammonium nitrate.

3. The composition of claim 2, wherein the at least one other solid oxidizer is selected from periodate salts, iodate salts, and metal oxides.

4. The composition of claim 3, wherein the at least one other solid oxidizer is selected from potassium periodate, potassium iodate, bismuth oxide, tungsten oxide, or cupric oxide.

5. The composition of claim 1, wherein the polymer binder decomposes by chain scission at a temperature of less than or equal to 350° C.

6. The composition of claim 1, wherein the polymer binder comprises a polyester, a polyether, or a polyester polyether copolymer.

7. The composition of claim 1, wherein the fuel comprises a metal powder and at least one of 3-nitro-1,2,4-triazol-5-one, 1,1diamino-2,2-dinoitroethylene, tetramethylolethane trinitrate, diethyleneglycol dinitrate, butylnitratoethylnitramine, or butanetriol trinitrate.

8. The composition of claim 7, wherein the fuel comprises a metal powder and at least one of 3-nitro-1,2,4-triazol-5-one or 1,1diamino-2,2-dinoitroethylene.

9. The composition of claim 1, further comprising a nitroplasticizer.

10. The composition of claim 1, further comprising a dodecaborate salt

11. A method of discharging a propellant, comprising:
combusting, in an enclosed vessel comprising at least one discharge opening, a composition comprising a solid oxidizer composition comprising ammonium nitrate and at least one other solid oxidizer having a decomposition or melting temperature of at least 500° C., a fuel, and a polymer binder that decomposes by chain scission to undergo liquefaction during combustion of the propellant composition; and
discharging combustion gases produced by combustion of the composition as a propellant through the discharge opening.

12. The method of claim 11 wherein the composition comprises at least 20 wt. % of ammonium nitrate.

13. The method of claim 12, wherein the at least one other solid oxidizer is selected from periodate salts, iodate salts, and metal oxides.

14. The method of claim 11, wherein the polymer binder comprises a polyester, a polyether, or a polyester polyether copolymer that decomposes by chain scission at a temperature of less than or equal to 350° C.

15. The method of claim 11, wherein the fuel comprises a metal powder and at least one of 3-nitro-1,2,4-triazol-5-one, 1,1diamino-2,2-dinoitroethylene, tetramethylolethane trinitrate, diethyleneglycol dinitrate, butylnitratoethylnitramine, or butanetriol trinitrate.
